(19) United States
(12) Patent Application Publication
(10) Pub. No.: US 2002/0134122 A1
(43) Pub. Date: Sep. 26, 2002

(54) Cylinder-pushing type of lock device

(76) Inventor: Chi-Yuan Li, Taipei (TW)

Correspondence Address: CHI-YUAN Li, P.O. BOX 96-405, Taipei, 106, TW

(21) Appl. No.: 09/819,959

(22) Filed: Mar. 26, 2001

(51) Int. Cl. E05B 29/04

(52) U.S. Cl. 70/366; 70/491

(57) ABSTRACT

A cylinder-pushing type of lock device, which mainly comprises a core cylinder mounted in a center casing hole of a lock casing; the core cylinder has a cylindrical hole for receiving a plurality of tumbler disks, which are pushed in place with a main spring underneath; one side of the lock casing has a latch bar groove; the core cylinder is furnished with an elongate slot for receiving a latch bar, which has a plurality of round cuts; the space between two round cuts is varied with the variation of moving distance of the tumbler disk so as to facilitate encoding variation; the key has a plurality of ring-shaped push surface so as to push the tumbler disks to a position opposite to the round cuts of the latch bar; in that case, the key can be turned to have the core cylinder moved to unlocked position.

### BACKGROUND OF THE INVENTION

1. Field of the Invention

This invention relates to a lock device, and particularly to a cylinder-pushing type of lock device.

2. Description of the Prior Art

In the conventional lock device under U.S. Pat. No. 5, 335,520 with a title of “Flat Lock”, it comprises a lock casing mounted with a lock cylinder; the inside of the lock casing is furnished with alternate sliding grooves and ring-shaped grooves. The lock cylinder is mounted with a plurality of sliding slices and one fixed slice; the inner side of every sliding slice has a hole with a push plate, of which the length is variable. The outer edge of every sliding slice has a fitting edge to be mated with the sliding groove in the lock casing. A positioning spring is mounted between two sliding slices; a push spring stronger that the positioning spring is mounted between a fixed slice and a sliding slice so as to fit the key, which has a cascade edge on one side. The space among the cascade edge of the key is so designed as to fit with the space among the ring-shaped groove in the lock casing. As soon as a key is plugged into a keyhole, the sliding slices will be pushed to positions corresponding to that of the ring-shaped grooves respectively so as to turn and to unlock the lock device. After the key is pulled out all the sliding slices will be pushed forwards to he lock-up position by means of the push spring.

### SUMMARY OF THE INVENTION

The prime object of the present invention is to provide an improvement on the patent application, “Lock Device to Be Unlocked by Pushing Tumbler Dicks” under Ser. No. 09/709,606; the present invention has a plurality of tumbler disks to be pushed with a ring-shaped push surface of a key, and the pushed distance is varied; when every tumbler disk is pushed to a position opposite to a round cut of the latch bar, the key can be turned to drive the core cylinder to an unlocked position.

Another object of the present invention is to provide a cylinder-pushing type of lock device, in which a latch bar is mounted between the lock casing and the core cylinder; the latch bar is furnished with a plurality of round cuts, among which the distance can be varied; the cylindrical hole of the core cylinder is loaded with a plurality of tumbler disks, of which all the outer round surfaces have equal thickness; the height of center of each tumbler disk is variable. The key has a plurality of ring-shaped push surfaces, and when the key is plugged into the key hole, all the tumbler disks will be pushed to a position opposite to the corresponding round cuts of the latch bar; then, a shift space will be provided between the outer round surface of every tumbler disk and the round cut of the latch bar; when the key drives the core cylinder to rotate, the latch bar will be pushed into a space between the elongate slot of the core cylinder and the cylindrical hole of the core cylinder without hindering the core cylinder to turn.

Still another object of the present invention is to provide a cylinder-pushing type of lock device, in which the tumbler disks in the cylindrical hole of the core cylinder are round plates respectively; the center of every tumbler disk has a cylindrical hole, but the diameter thereof is different, and the height and diameter of the contact surface are also different; the top surface of the cylindrical hole thereof is to be pushed by the ring-shaped push surface of the key; the top surface and the bottom surface of every tumbler disk have a given height, which can be varied so as to facilitate encoding variation.

A further object of the present invention is to provide a cylinder pushing type of lock device, in which the tumbler disks in the cylindrical hole of the core cylinder are pushed with a main spring, which can push all the tumbler disks back to the original position upon the key being pulled back.

A still further object of the present invention is to provide a cylinder-pushing type of lock device, in which each of the tumbler disks is substantially a round plate, and the outer round surface of each tumbler disk has a ring-shaped groove for receiving a positioning ring; when the ring-shaped push surface of the key pushes the tumbler disks to move in the cylindrical hole of the core cylinder, the tumbler disks would not have a bias motion; otherwise, the tumbler disks will be moved in a bias motion so as to prevent the lock device from being unlocked or picked illegally.

Yet another object of the prevent invention is to provide a cylinder-pushing type of lock device, in which each of the tumbler disks in the cylindrical hole of the core cylinder has an outer round surface with a ring-shaped groove, and a positioning ring is mounted in the ring-shaped groove; the positioning ring is substantially a flexible metal ring with a cut; the positioning ring may also be an O-ring made of rubber.

Yet still another object of the present invention is to provide a cylinder-pushing type of lock device, in which one side of the core cylinder has an elongate slot, which is substantially a cylindrical slot, and both ends thereof are furnished with two short rods respectively; both ends of the core cylinder are furnished with two ring-shaped grooves respectively for receiving two balance springs; one end of each balance spring has a recess part to hole one short rod so as to suspend the latch bar in place, and to limit the short rod from shifting unintentionally, and also to provide a pull-back force normally.

Yet a further object of the present invention is to provide a cylinder-pushing type of lock device, in which the latch bar mounted in the elongate slot in one side of the core cylinder is furnished with a plurality of round cuts which have different height varied with and corresponding to the ring-shaped push surfaces of the key.

Yet still a further object of the present invention is to provide a cylinder-pushing type of lock device, in which the height of the tumbler disks in the cylindrical hole is designed to mate with the distance between every two round cuts of the latch bar so as to facilitate encoding variation, and to prevent two lock devices from being unlocked alternately.

Yet still an additional object of the present invention is to provide a cylinder-pushing type of lock device, in which bottom of the tumbler disks is mounted with a main spring and a retaining plate so as to form into a tumbler disk unit; distance between every two ring-shaped push surfaces and distance between every two round cuts being used for encoding variation.

Yet still another additional object of the present invention is to provide a cylinder-pushing type of lock device, in which the latch bar in the elongate slot of the core cylinder is suspended in recess parts of the two balance springs; the core cylinder of the lock device able to be disassembled after being unlocked, and then only the latch bar being removed so as to replace with a new one, and a new key, i.e., a new lock device with a new encoding condition being furnished.

### BRIEF DESCRIPTION OF THE DRAWINGS

FIG. 1 is a disassembled view of the present invention between the key and the lock device.

FIG. 2 is a disassembled view of the present invention, showing the parts and assemblies thereof.

FIG. 3 is a sectional view of the present invention, showing the lock device in lock-up condition.

FIG. 4 is a sectional view of the present invention, showing the lock device in unlocked condition,

FIG. 5 is a fragmental section view of the present invention, showing a latch bar mounted on a balance spring, and a plurality of tumbler disks set in lock-up condition.

FIG. 6 is a fragmental section view of the present invention, showing the tumbler disks pushed in unlocked condition.

FIG. 7 is a sectional view of the present invention, showing the structure along line 7-7 in FIG. 3.

FIG. 8 is a sectional view of the present invention, showing the latch bar set in unlocked condition as shown in FIG. 7.

FIG. 9 is a sectional view of the present invention, showing the structure along line 9-9 in FIG. 3.

FIG. 10 is a sectional view of the present invention, showing the latch bar set in unlocked condition.

FIG. 11 is a sectional view of the present invention, showing the latch bar shown in FIG. 9 being turned.

FIG. 12 is a sectional view of the present invention, showing the tumbler disks having the same thickness and the position variety of the latch bar.

FIG. 13 is a fragmental perspective view of the present invention, showing the tumbler disks having different cylindrical stems to provide combination variety for the lock device.

FIG. 14 is a fragmental perspective view of the present invention, showing the key designed into cross-shaped structure.

### DETAILED DESCRIPTION OF THE PREFERRED EMBODIMENT

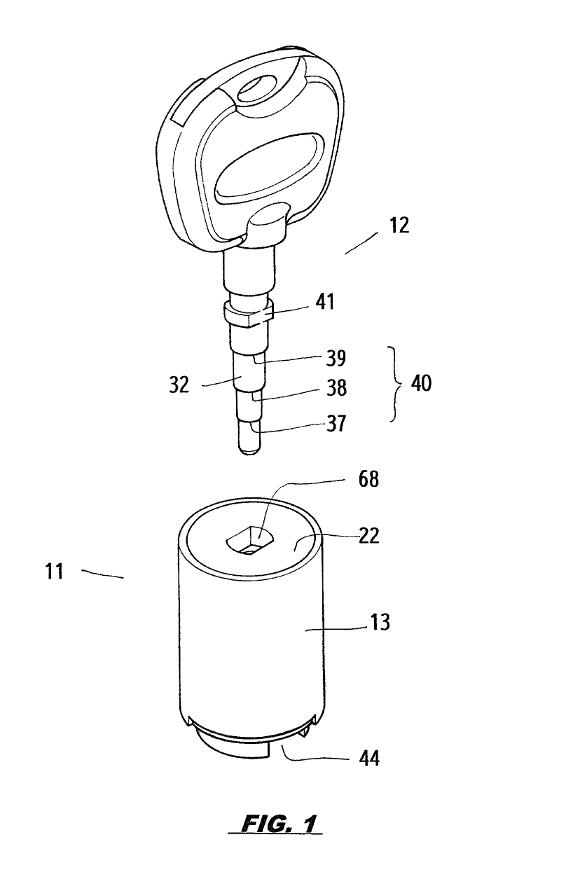

This invention relates to a cylinder-pushing type of lock device; as shown in FIGS. 1 to 4, the lock device 11 comprises a key 12, a lock casing 13, a tumbler disk unit 14, a latch bar 15, two balance springs 20 and 21, a core cylinder 22 and a retaining plate 23. The tumbler disk unit 14 includes at least three tumbler disks 16, 17 and 18, and a main spring 19, which are mounted in a cylindrical hole 26 of the core cylinder 22, and retained in place with a retaining plate 23; the main spring 19 normally pushes the tumbler disks 16, 17 and 18 upwards to the key hole 68; the latch bar 15 is mounted in an elongate slot 27 on one side of the core cylinder 22, and is held in place by means of two balance springs 20 and 21 on both ends thereof; the balance springs 20 and 21 are mounted in the latch bar hole 64 of the lock casing 13 so as to have the latch bar 15 suspended in a slot between the lock casing 13 and the core cylinder 22, and to limit the core cylinder 22 from rotating. After the key 12 plugs into the key hole 68 to push the tumbler disks 16, 17 and 18 into the corresponding round cuts 47, 48 and 49 of the latch bar 15, a gap will be provided between the latch bar 15 and the outer round surface 51 of the tumbler disks to facilitate the core cylinder 22 to turn for unlocking the lock device; in case of the three tumbler disks 16, 17 and 18 not engaging the corresponding round cuts 47, 48 and 49 of the latch bar 15, the key 12 will be unable to turn the core cylinder 22 and to unlock the lock device.

As shown in FIGS. 1 to 6, the lock casing 13 of the lock device 11 has a casing hole 62 for receiving the core cylinder 22; above the casing hole 62, there is a flange hole 63 for receiving the flange 24 of the core cylinder 22. One side of the casing hole 62 has a latch bar groove 64, of which both sides are furnished with two curved surfaces 65. The center of the core cylinder 22 has a cylindrical hole 26, of which the top has a key hole 68; one side of the core cylinder 22 is furnished with an elongate slot 27 in communication with the cylindrical hole 26. The upper end and the lower end of the elongate slot 27 are furnished with two ring grooves 28 and 29 for receiving to balance springs 20 and 21 respectively; one end of every balance spring has a hook 70 to hook on one side of the ring groove 28 (or 29), while the other end thereof has a recess part 71, After the elongate slot 27 of the core cylinder 22 is mounted with a latch bar 15, the recess parts 71 of the balance springs 20 and 21 will hook the short rods 45 and 46 of the latch bar 15 respectively so as to suspend the latch bar 15 in place. When the core cylinder 22 is mounted in the casing hole 62 of the lock casing 13, the latch bar 15 should be plugged in a space between the latch bar groove 64 of the lock casing 13 and the elongate slot 27 of the core cylinder 22.

The core cylinder 22 plugged into the casing hole 62 and the locking casing 13 are assembled together into one unit; before the assembling, the cylindrical hole 26 of the core cylinder 22 must be loaded with at least three tumbler disks 16, 17 and 18; a main spring 19 is mounted under the first tumbler disk 16, and then a flat plate 42 is plugged into a plug groove 31 on the lower end of the core cylinder 22, and fastened in place; the flat plate 42 is used for supporting the main spring 19 upon the tumbler disks 16, 17 and 18 being mounted in the cylindrical hole 26 of the core cylinder 22; the upper end of the main spring 19 will push the tumbler disks 16, 17 and 18 upwards against the key hole 68.

The upper and lower ends of the elongate slot 27 in the core cylinder 22 are furnished with two ring grooves 28 and 29 respectively, which are loaded with two balance springs 20 and 21 respectively. One end of every balance spring 20 (or 21) has a hook 70, while the other end thereof has a recess part 71. After the balance spring 20 and 21 are mounted in the ring grooves 28 and 29 respectively, the hook 70 of every balance spring is hooked to the cut surface the core cylinder, while the recess part 71 of other end thereof is mounted on the upper and lower ends of the elongate slots respectively. The inner diameter of the recess part 71 is designed to fit the outer diameter of the two short rods 45 and 46.

The elongate slot 27 in one side of the core cylinder 22 is used for receiving a latch bar 15, of which both ends are furnished with two short rods respectively; after the core cylinder 22 is mounted in the elongate slot 27, the short rods 45 and 46 of the latch bar will be mounted in the recess parts 71 of the two balance springs 20 and 21 respectively so as to have both ends of the latch bar 15 suspended in the elongate slot 27 without shifting.

After the latch bar 15 is loaded into the elongate slot 27 of the core cylinder 22, and the core cylinder 22 is loaded into the casing hole 62 of the lock casing 13, the latch bar 15 will be plugged in a space between the latch bar groove 64 of the lock casing 13 and the elongate slot 27 of the core cylinder 22. The lower end of the core cylinder 22 has a ring-shaped groove 43 for receiving a retaining plate 23, which can hold the core cylinder 22 in place without moving upwards; under the ring-shaped groove 43, there is a coupling groove 44 for mounting a transmission member to be actuated with the core cylinder 22.

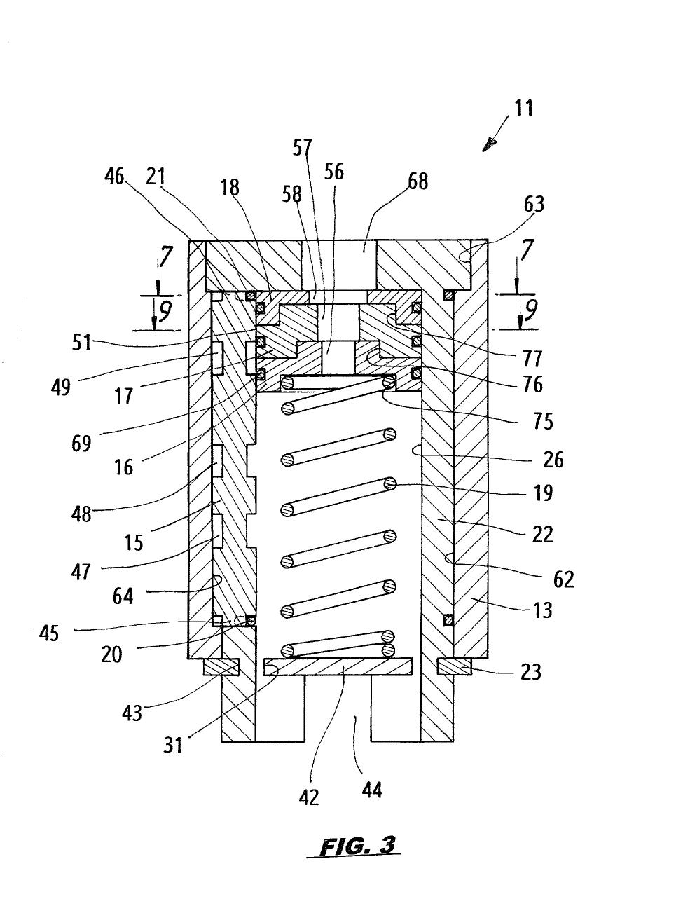

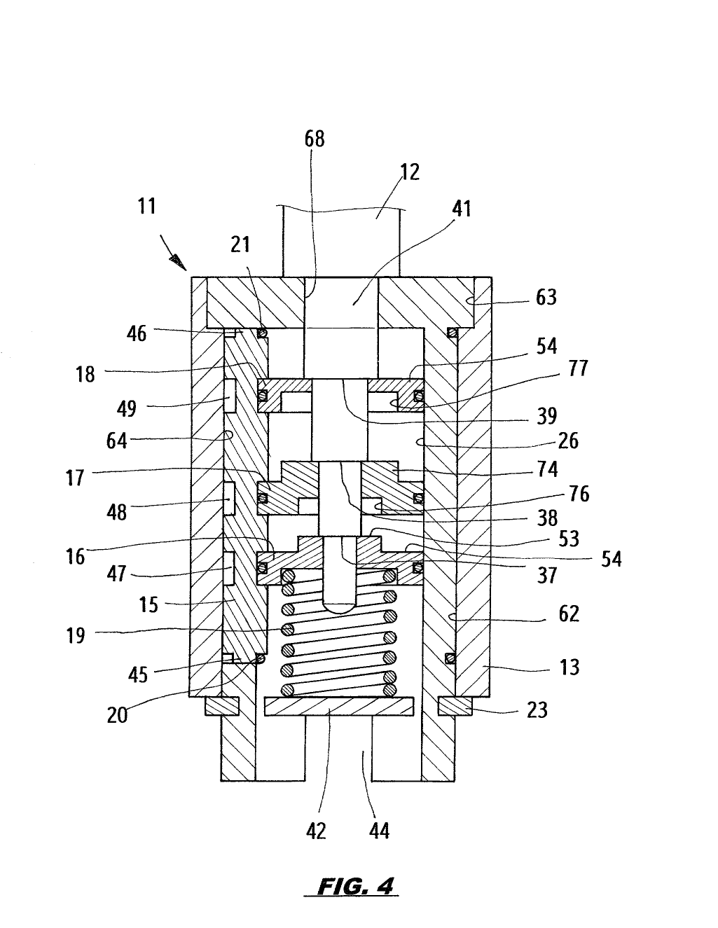

After the assembly being mounted in place as shown in FIG. 3, all the tumbler disks 16, 17 and 18 mounted on the core cylinder 22 will be pushed upwards by the main spring 19 so as to have the three tumbler disks 16, 17 and 18 attached to the inner side of the key hole 68; as shown in FIG. 4, the key 12 having a plurality of ring-shaped push surface 40 (37, 38 and 39) is plugged into the key hole 68 of the lock device 11; if the code of the ring-shaped push surface 40 can match with that of the round cuts 47, 48 and 49 of the latch bar 15, the key 12 plugged into the key hole 68 will push the three tumbler disks 16, 17 and 18 to the unlocking position respectively; in that case, the latch bar 15 suspended between the elongate slot 27 and the latch bar groove 64 of the lock casing 13 will be moved along the curved surface be 65 of the latch bar groove 64 to enter the elongate slot 27 upon the key 12 turning because of the outer round surfaces 51 of the tumbler disks 16, 17 and 18 being moved to a position beside the round cuts 47, 48 and 49 of the latch bar 15 respectively to form into a space by means of the round cuts 47, 48 and 49,

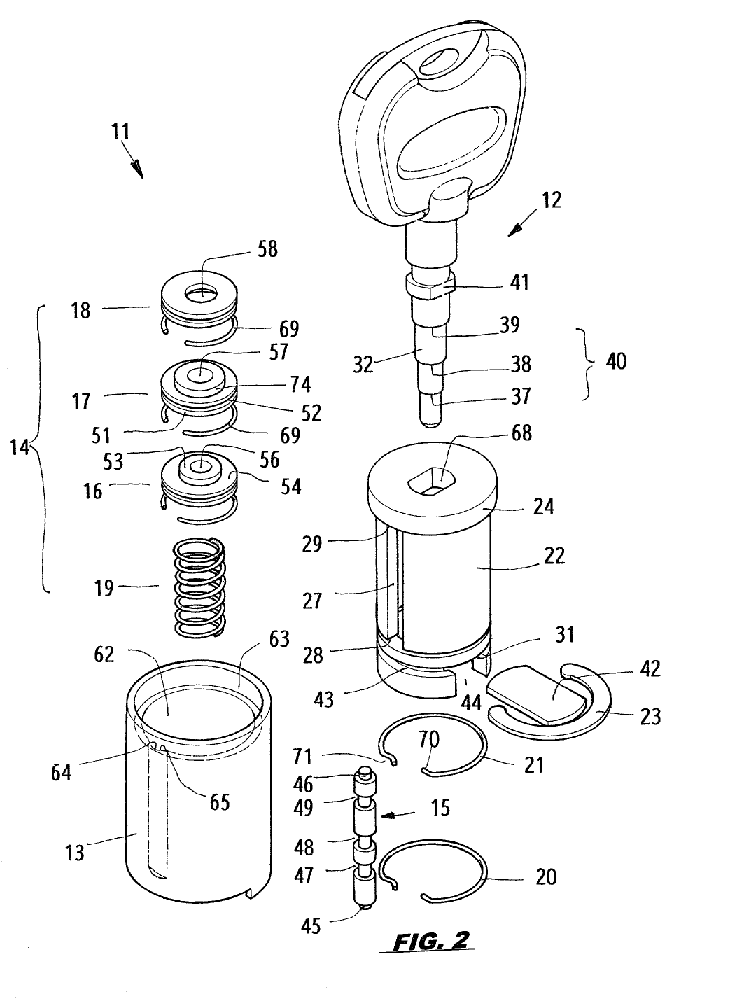

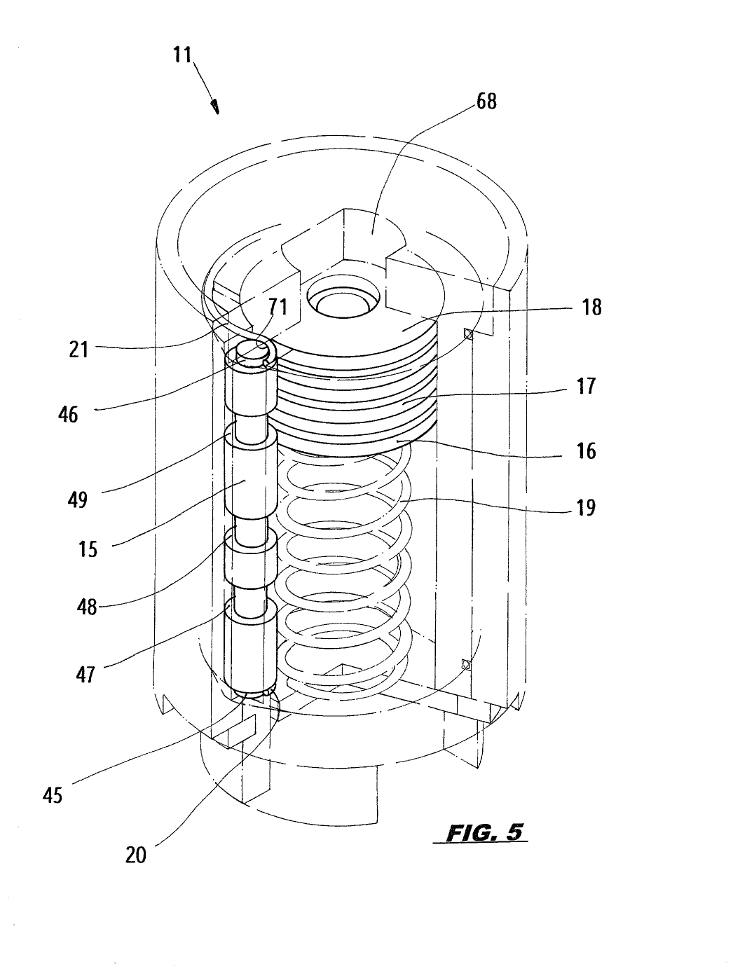

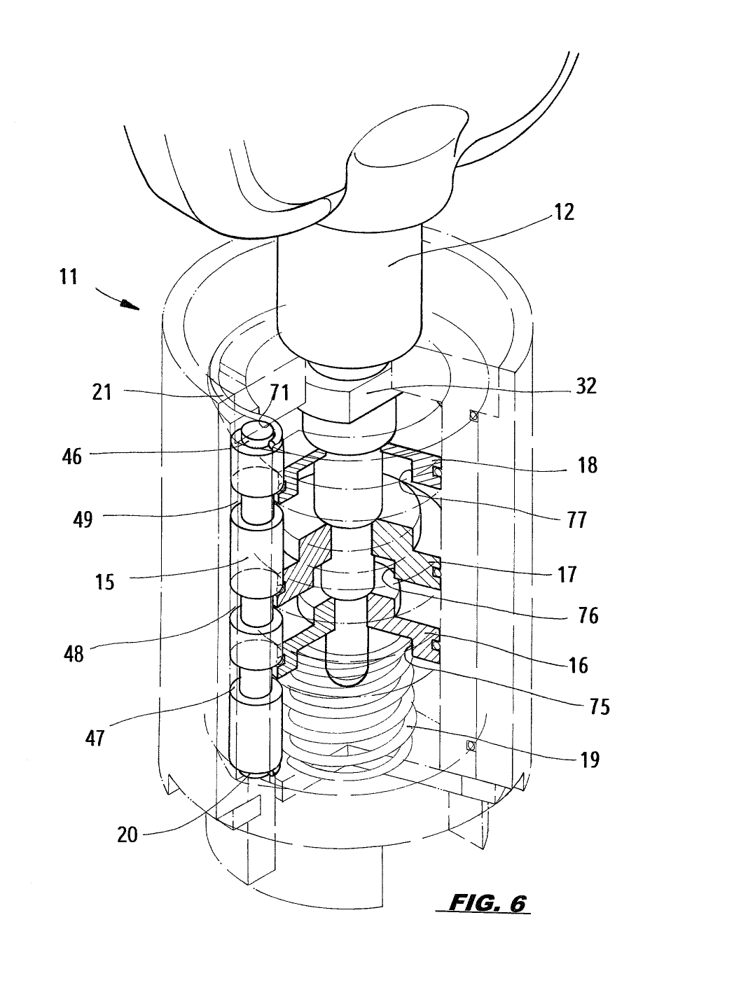

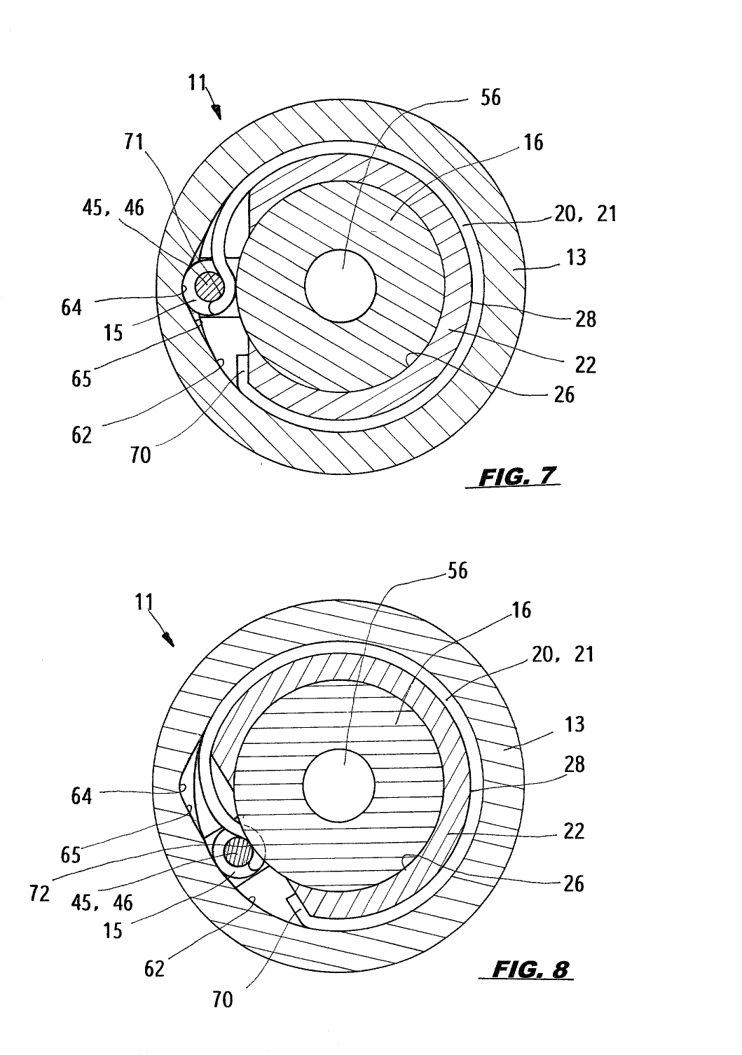

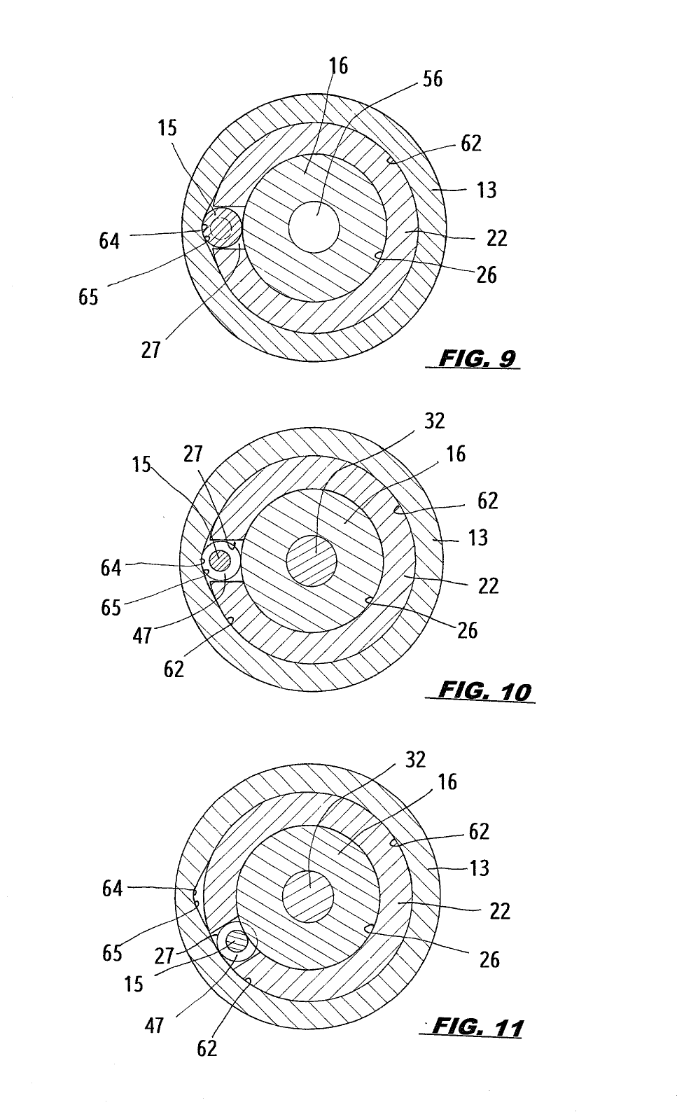

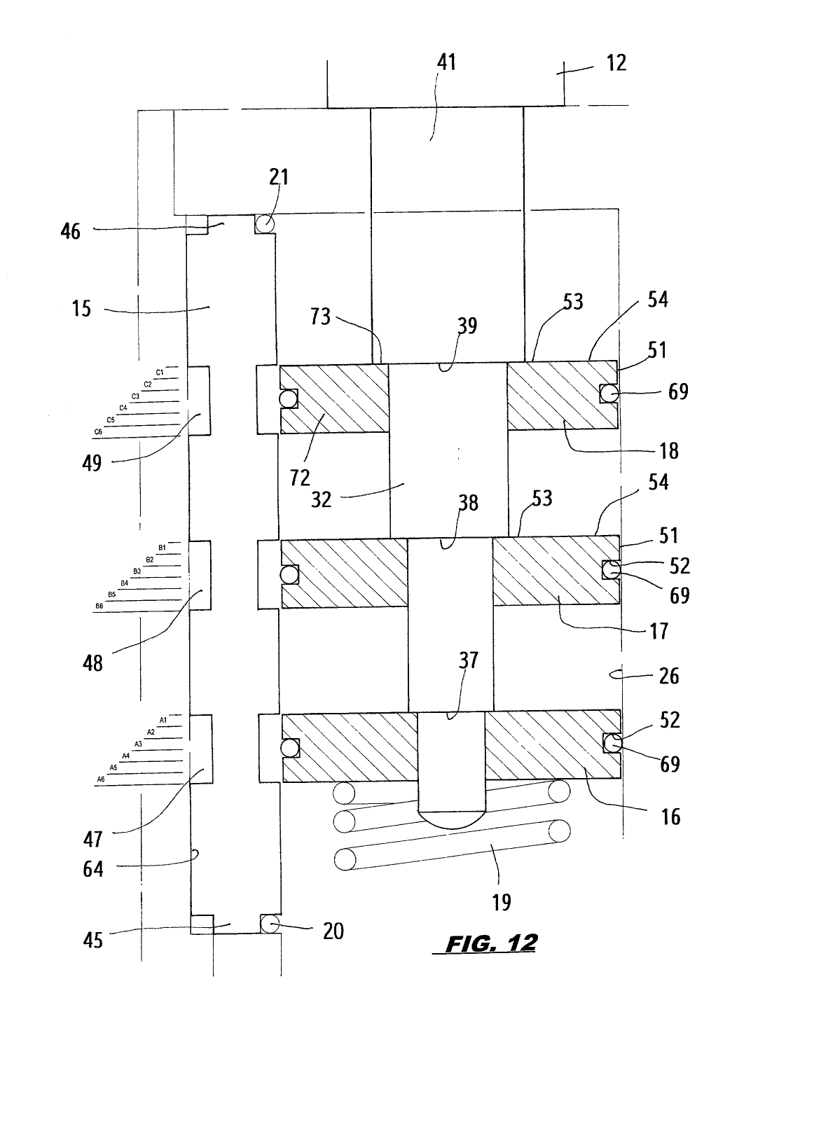

As shown in FIG. 6, the latch bar 15 has already had a flexibility because of both ends thereof being suspended in the recess parts 71 of the balance springs 20 and 21; when the key 12 pushes the three tumbler disks 16, 17 and 18 to unlocking condition, the latch bar is still suspended in a space between the elongate slot 27 of the core cylinder 22 and the latch bar groove 64 of the lock casing 13 without moving inwards. If the key 12 is turned, the engaging shoulder 41 of the key 12 will engage with the key hole 68 so as to drive the core cylinder 22 to turn; as shown in FIG. 9, the latch bar 15 is plugged in a space between the latch bar groove 64 of the lock casing 13 and the elongate slot 27 of the core cylinder 22 without having any room to move. As shown in FIGS. 2, 6 and 10, a key 12 of the lock device 11 is plugged into the key hole 68 to push the tumbler disks 16, 17 and 18 to a position opposite to the round cuts 47, 48 and 49 of the latch bar 15 respectively. Since the latch bar 15 is suspended in its original position with the balance springs 20 and 21. As shown in FIGS. 2, 6, 8 and 11, when the key 12 drives the core cylinder 22 to turn, the latch bar 15 will move along the curved surface 65 into the casing hole 62, and then the latch bar 15 in its original position will be moved in a space between the elongate slot 27 of the core cylinder and the cylindrical hole 26. Before the key 12 is turned back to the latch bar groove 64, the latch bar 15 will move along the inner surface of the lock casing 13 because of the effect of the balance springs 20 and 21. When the core cylinder 22 is rotated back, the latch bar 15 will automatically return to the latch bar groove 64 as a result of force of the balance springs 20 and 21.

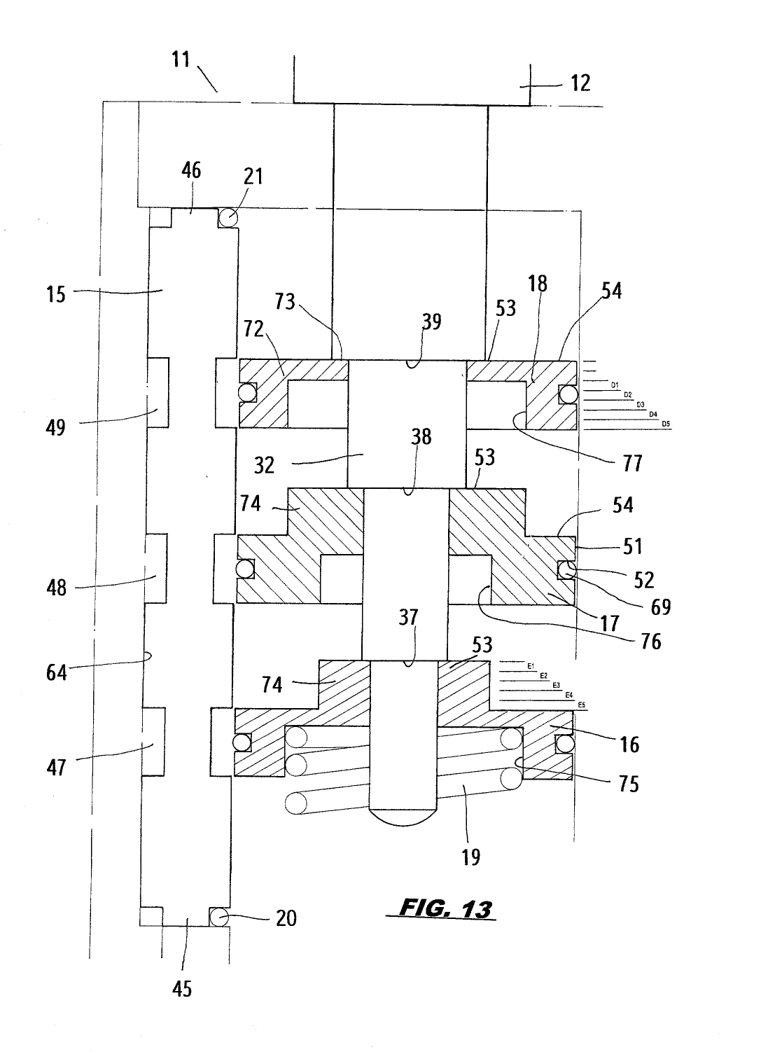

The tumbler disk unit 14 loaded in the cylindrical hole 26 of core cylinder 22, as shown in FIGS. 2 to 6 and 12, includes at least three tumbler disks 16, 17 and 18, and a main spring 19; every tumbler disk includes a round surface 72 and a push surface 73; the round surface 72 is substantially a disk, of which the outer round surface 51 of the round surface 72 has a diameter slightly smaller than that of the cylindrical hole 26 of the core cylinder 22; the outer round surface 51 of the round surface 72 is furnished with a ring-shaped groove 52 for receiving a position ring 69, of which the outer edge is in contact with the cylindrical hole 26 of the core cylinder 22; the positioning ring 69 is substantially a ring spring having a cut; the position ring 69 may be an O-ring made of rubber to be in contact with the cylindrical hole 26 of the core cylinder 22, and it will move upon being pushed with the ring-shaped push surface 40 of the key 12. After the key 12 is pushed out, the main spring 19 can easily push the tumbler disks 16, 17 and 18 to their original position because of the friction force between the positioning ring 69 and the cylindrical hole 26 of the core cylinder 22 being very small; in other words, since the positioning rings 69 of the tumbler disks 16, 17 and 18 are moved along the cylindrical hole 26 of the core cylinder 22, it provides a steady push effect. Since all the tumbler disks 16,17 and 18 will be pushed with the ring-shaped push surface 40 of the key 12, the key 12 must be a correct key; otherwise, each tumbler disk will not be pulled with a steady force, and will have a slight tilt; in that case, the lock device can not be unlocked.

The thickness of the round surface 72 of all the tumbler disks 16, 17 and 18 is designed to match with the height of all the round cuts 47, 48 and 49 respectively of the latch bar 15. As soon as the tumbler disk 16, 17 and 18 are push to a position opposite to the corresponding round cuts 47, 48 and 49 of the latch bar 15, the key 12 can be turned to drive the core cylinder to rotate, I.e., the round cuts 47, 48 and 49 of the latch bar 15 have engaged with the round surfaces 72 of the tumbler 16, 17 and 18 respectively so as to have the latch bar 15 moved, and to unlock the lock device.

The center of each of the tumbler disks 16, and 17 and 18 is furnished with a cylindrical hole 56 (or 57 or 58), of which the diameter is different from one another. Each of the cylindrical holes 56, 57 and 58 has a top flat surface 53; as shown in FIGS. 3, 4 and 12, the top flat surface 54 has a diameter equal to that of the outer round surface 51, i.e., the flat surface 53 and the top flat surface 54 are in one flat surface. The distance among the ring-shaped push surfaces 40 of the key 12 is varied with the code variation (A1 . . . A6, B1 . . . B6, C1 . . . C6) of the round cuts 47, 48 and 49 on the latch bar 15 so as to provide a plurality of lock devices 11 merely by changing one code between the latch bar 15 and the key 12, i.e., one key can unlock one lock device only.

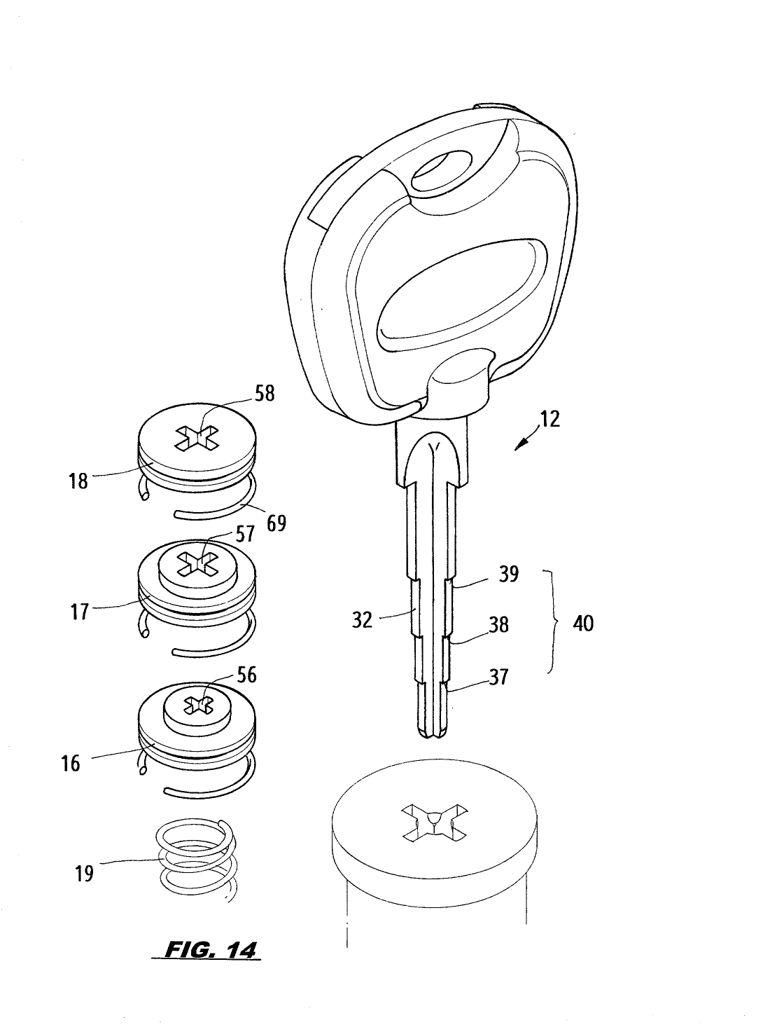

As shown in FIGS. 3, 4 and 13, the centers of the tumbler disks 16, 17 and 18 of the tumbler disk unit 14 have cylindrical holes 56, 57 and 58 with different diameters; the top flat surfaces 53 of the such cylindrical holes is furnished on a cylindrical stem 74; the height of the cylindrical stem 74 of every tumbler disk 16 (or 17 or 18) is different from each other so as to provide variation of space among the ring-shaped push surfaces 40 of the key 12, and variation of the latch bar 15; likewise, the outer diameter of the cylindrical stem 74 on the tumbler disks 16, 17 and 18 must have a given height and strength to for the cylindrical holes 56, 57 and 58; each of the cylindrical stems 74 has a different diameter; the height of the cylindrical stem 74 on the tumbler disks 16, 17 and 18 is divided into seven equal sections. The thinnest part of the flat surface 53 has a thickness of two sections, and the rest portion thereof is divided into five sections (D1 . . . D5). The variation of each section can provide the latch bar 15 and the key 12 with more encoding variation for the ring-shaped push surfaces 40.

As shown in FIGS. 2, 3, 12 and 13, all the tumbler disks 16, 17 and 18 are pushed and attached together by the main spring 19 before the lock device 11 being unlocked. If a person looks into the key hole 68, the encoding condition of the tumbler disks 16, 17 and 18 can not be read and found out. If one of the height, the thickness of the tumbler disks 16, 17 and 18, and the round cuts 47, 48 and 49 of the latch bar 15 are changed by one single section, the ring-shaped push surface 40 between the key 12 and the latch bar 15 will vary accordingly; therefore, the encoding condition can be distinguished by seeing the thickness of the cylindrical holes 56, 57 and 58 of the tumbler disks 16, 17 and 18 respectively. In order to have the three tumbler disks 16, 17 and 18 closely attached together in the cylindrical hole 26 of the core cylinder 22, the top flat surface 53(or 61) and the outer flat surface 54 of the third tumbler disk 18 nearing the key hole 68 are on the same surface, which is closely attached to the inner surface of the cylindrical hole 26 of the core cylinder 22. A third tumbler disk 18 has a cylindrical stem 74 with a top flat surface 53, which can also be attached to the inner surface of the cylindrical hole 26 of the core cylinder 22.

The two adjacent tumbler disks are normally in close contact with each other before the lock device 11 being unlocked. The bottom sides of all tumbler disks 16, 17 and 18 are furnished with three round recess holes 75, 76 and 77 respectively, of which the diameters are slightly larger than the outer diameters of the cylindrical stems 74 on the tumbler disks 16, 17 and 18 in regular order so as to receive the cylindrical stems 74 of the tumbler disks 16, 17 and 18; in that case, when the equal sections (E1 . . . E5) of the height of the cylindrical stem 74 of the tumbler disk 16 (17 or 18) are varied, the cylindrical stem 74 will have a given receiving space, i. e., the round cuts 47, 48 and 49 of the latch bar 15 can be varied within a scope (A1 . . . A6, B1 . . . B6, C1 . . . C6) as expected.

The lock device 11 of the present invention includes at least three tumbler disks 16, 17 and 18; by means of the position difference of the ring-shaped push surfaces 40 of the key 12, and the position difference of the round cuts 47, 48 and 49 of the latch bar 15, every lock device 11 has a different encoding variation, and one key can only unlock one specific lock device.

The key 12 used for pushing the tumbler disks 16, 17 and 18, as shown in FIGS. 1 and 2, is furnished with a plurality of cylindrical key surfaces 32, and of ring-shaped push surfaces 40 (37, 38 and 39) so as to push the tumbler disks 16, 17 and 18 to a position opposite to the round cuts 47, 48 and 49 of the latch bar 15, and then the latch bar 15 can be moved, and the key 12 can drive the core cylinder 22 to turn; finally, the lock device is unlocked.

As shown in FIG. 14, the key 12 used for pushing the tumbler disks 16, 17 and 18 to move is furnished with a cross-shaped key surface or the like in addition to the cylindrical key surface 32 as mentioned in the aforesaid embodiment. The center of each of the tumbler disks 16, 17 and 18 is also furnished with a cross-shaped hole for fitting the key surface. The cross-shaped key surface is furnished with a plurality of symmetrical push surfaces so as to push the tumbler disks 16, 17 and 18 to a position to the corresponding round cuts 47, 48 and 49 of the latch bar 15, and the lock device 11 will be unlocked upon the key 12 being rotated. A key without balanced push surface with be unable to push the tumbler disks 16, 17 and 18 to a position opposite to the round cuts 47, 48 and 49 of the latch bar 15 respectively, and then the core cylinder 22 can not be turn to unlock the lock device.

Likewise, any incorrect tool will be unable to push the tumbler disks 16, 17 and 18 to a position opposite to the round cuts 47, 48 and 49, and then the lock device can not be unlocked.

According to the aforesaid description of embodiments, the structure features of the tumbler disk unit 14 in the core cylinder 22 of the lock device and other parts thereof have been disclosed completely; after a key 12 is plugged into the key hole 68 to push the tumbler disks 16, 17 and 18 to a position opposite to the round cuts 47, 48 and 49 of the latch bar 15 respectively so as to provide the latch bar 15 between the lock casing 13 and the core cylinder 22 with a shift space, and then the key 12 can be rotated to drive the core cylinder 22 to move, and the lock device will be unlocked easily. Since the aforesaid embodiments have disclosed the structure relation thereof, the present invention has provided apparent improvement in the field of lock device, and such features are never anticipated and achieved by any person in the field; therefore, the structure of the present invention is deemed unique.

What is claimed is:

1. A cylinder-pushing type of lock device comprising:
a lock casing having a casing hole, and one side of said casing hole furnished with a latch bar groove; said casing hole used for mounting an assembly therein;
a core cylinder having a cylindrical hole for receiving a tumbler disk unit, and one side of said core cylinder furnished with a through elongate slot for receiving a latch bar;
a tumbler disk unit including:
a plurality of tumbler disks, of which each having a round surface with a cylindrical hole in center thereof for receiving a key;
a main spring, of which one end pushing against a most outer tumbler disk while other end thereof pushing against a flat plate so as to push all tumbler disks towards a key hole;
a latch bar mounted between a latch bar groove of said lock casing and an elongate slot of said core cylinder, and surface of said latch bar furnished with a plurality of round cuts.

2. A cylinder-pushing type of lock device as claimed in claim 1, wherein said elongate slot in one side of said core cylinder is used for receiving a latch bar; both upper and lower ends of said core cylinder furnished with two ring-shaped grooves respectively for receiving balance springs; one end of each said balance spring furnished with a hook to hold one end surface of said ring-shaped groove, while other end thereof having a recess part mounted on a short rod of said latch bar so as to have said latch bar suspended in said elongate slot.

3. A cylinder-pushing type of lock device as claimed in claim 1, wherein said latch bar mounted in said elongate slot of said core cylinder is furnished with two short rods on both ends thereof, and said short rods being mounted in said recess parts of said balance springs respectively.

4. A cylinder-pushing type of lock device as claimed in claim 1, wherein said latch bar mounted in said elongate slot is furnished with at least three round cuts, and height of each said round cut being slightly larger than thickness of said corresponding tumbler disk; each said round cut designed to have a regular distance variation so as to facilitate encoding variation of said lock device.

5. A cylinder-pushing type of lock device as claimed in claim 1, wherein at least three said tumbler disks are mounted in said cylindrical hole of said core cylinder.

6. A cylinder-pushing type of lock device as claimed in claim 1, wherein outer round surface of each said tumbler disk in said cylindrical hole is furnished with a ring-shaped groove which having a flexible position ring to be in close contact with inner surface of said cylindrical hole of said core cylinder.

7. A cylinder-pushing type of lock device as claimed in claim 1, wherein center of each said tumbler disk is furnished with a cylindrical hole for receiving ring-shaped push surface, and said cylindrical hole furnished with a cylindrical key surface to fit with said cylindrical key surface.

8. A cylinder-pushing type of lock device as claimed in claim, wherein round surface of each said tumbler disk is furnished with a ring-shaped push surface and a cylindrical hole which being designed into a cross-shaped hole or the like; said key push surface of each said tumbler disk designed into a cross shape or the like.

9. A cylinder-pushing type of lock device, wherein a cylindrical hole of a core cylinder is mounted with a tumbler disk unit, and every tumbler disk in said tumbler disk unit being substantially a round plate; outer round surface of said round plate furnished with a ring-shaped groove for receiving a positioning ring; center of said round plate furnished with a key push surface and a through cylindrical hole.

10. A cylinder-pushing type of lock device as claimed in claim 1, wherein said ring-shaped groove on outer round surface of every said tumbler disk in said tumbler disk unit is mounted with a positioning ring, which being substantially a flexible metal ring with a cut.

11. A cylinder-pushing type of lock device as claimed in claim 1, wherein said ring-shaped groove on outer round surface of every said tumbler disk in said tumbler disk unit is mounted with a positioning ring, which being substantially an O-ring made of rubber.

12. A cylinder-pushing type of lock device as claimed in claim 1, wherein every said tumbler disk in said tumbler disk unit has a top and a bottom flat surfaces in center thereof, and both said flat surfaces being one flat surface.

13. A cylinder-pushing type of lock device as claimed in claim 1, wherein said top flat surface of every said tumbler disk in said tumbler disk unit has a cylindrical stem erected, and top surface of said cylindrical stem being flat.

14. A cylinder-pushing type of lock device as claimed in claim 1, wherein said bottom flat surface of every said tumbler disk in said tumbler disk unit is furnished with a round recess hole.
